(19) United States
(12) Patent Application Publication
(10) Pub. No.: US 2026/0153606 A1
(43) Pub. Date: Jun. 4, 2026

(54) VEHICULAR ULTRASONIC SENSING SYSTEM WITH AUTOMATIC SENSOR CALIBRATION

(71) Applicant: Magna Electronics Inc., Auburn Hills, MI (US)

(72) Inventor: Jason R. Zalev, Thornhill (CA)

(21) Appl. No.: 19/392,583

(22) Filed: Nov. 18, 2025

Related U.S. Application Data
(60) Provisional application No. 63/727,782, filed on Dec. 4, 2024.

(51) Int. Cl. G01S 7/52; G01S 15/00; G01S 15/931

(52) U.S. Cl. CPC G01S 7/52006; G01S 15/006; G01S 15/931

(57) ABSTRACT

A method for calibrating a sensor system includes disposing a plurality of ultrasonic sensors of the sensor system at a vehicle. The method includes determining, for each ultrasonic sensor of a pair of ultrasonic sensors, and based on sensor data captured by the respective ultrasonic sensor, a probability that the respective ultrasonic sensor correctly detects an object in a field of sensing of the respective ultrasonic sensor and determining a probability that the respective ultrasonic sensor incorrectly detects an object that is not in the field of sensing of the respective ultrasonic sensor. The method includes calibrating the sensor system based at least in part on (i) the determined probability that each ultrasonic sensor of the pair of ultrasonic sensors correctly detects an object and (ii) the determined probability that each ultrasonic sensor of the pair of ultrasonic sensors incorrectly detects an object.

### CROSS REFERENCE TO RELATED APPLICATION

The present application claims the filing benefits of U.S. provisional application Ser. No. 63/727,782, filed Dec. 4, 2024, which is hereby incorporated herein by reference in its entirety.

### FIELD OF THE INVENTION

The present invention relates generally to a vehicle sensing system for a vehicle and, more particularly, to a vehicle sensing system that utilizes one or more ultrasonic sensors at a vehicle.

### BACKGROUND OF THE INVENTION

Use of ultrasonic sensors in vehicle sensing systems is common and known. Examples of such known systems are described in U.S. Pat. Nos. 9,915,557 and 10,234,548, which are hereby incorporated herein by reference in their entireties.

### SUMMARY OF THE INVENTION

A method for calibrating a sensor system includes disposing a plurality of ultrasonic sensors of the sensor system at a vehicle, each ultrasonic sensor of the plurality of ultrasonic sensors sensing exterior of the vehicle. The method further includes determining, for each ultrasonic sensor of a pair of ultrasonic sensors of the plurality of ultrasonic sensors, a probability that the respective ultrasonic sensor of the pair of ultrasonic sensors, based on sensor data captured by the respective ultrasonic sensor, correctly detects an object in a field of sensing of the respective ultrasonic sensor. The method also includes determining, for each ultrasonic sensor of the pair of ultrasonic sensors, a probability that the respective ultrasonic sensor of the pair of ultrasonic sensors, based on sensor data captured by the respective ultrasonic sensor, incorrectly detects an object that is not in the field of sensing of the respective ultrasonic sensor. The sensor system is calibrated based at least in part on (i) the probability that each ultrasonic sensor of the pair of ultrasonic sensors correctly detects an object and (ii) the probability that each ultrasonic sensor of the pair of ultrasonic sensors incorrectly detects an object.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensing system that incorporates ultrasonic sensors;

FIG. 2 is a set of spatial maps illustrating a probability of detection for various pairs of sensors of an ultrasonic sensor system;

FIG. 3 is a set of spatial maps illustrating a probability of a false background detection for various pairs of sensors of an ultrasonic sensor system;

FIG. 4A is a set of spatial maps illustrating a probability of triangulation for various pairs of sensors of an ultrasonic sensor system;

FIG. 4B is a spatial map illustrating an overall probability of triangulation for an ultrasonic sensor system;

FIG. 5A is a set of spatial maps illustrating an overall probability of clutter for various pairs of sensors of an ultrasonic sensor system;

FIG. 5B is a spatial map illustrating an overall probability of triangulating a false detection for an ultrasonic sensor system;

FIG. 6 is a block diagram for determining a true positive rate of detection and a false positive rate of detection to refine a calibration parameter;

FIG. 7 is set of maps illustrating a gradient of probability of triangulation with respect to threshold parameters for individual ultrasonic sensors;

FIG. 8A is a spatial map of a true positive rate of detection and a false positive rate of detection of an ultrasonic sensor system that has been manually calibrated;

FIG. 8B is spatial map of a true positive rate of detection and a false positive rate of detection of an ultrasonic sensor system that has been calibrated using a calibration method including an optimization algorithm;

FIG. 8C is a graph of a convergence of a false negative rate of detection of an ultrasonic sensor system plotted across iterations of an optimization algorithm;

FIG. 9 is a set of spatial maps of an expected signal amplitude for various pairs of sensors of an ultrasonic sensor system;

FIG. 10 is a set of spatial maps of an expected background noise for various pairs of sensors of an ultrasonic sensor system;

FIG. 11 is a mapping station for collecting experimental sensing data from an ultrasonic sensor system;

FIG. 12A is a graph of sensor measurements, where an amplitude of a signal of an ultrasonic sensor reflected by a pole is plotted against a direct distance between the pole and the ultrasonic sensor; and

FIG. 12B is a graph of modeled field profiles of an ultrasonic sensor and measured field profiles of an ultrasonic sensor.

### DESCRIPTION OF THE PREFERRED EMBODIMENTS

A vehicle sensing system and/or driver or driving assist system and/or object detection system and/or alert system operates to capture sensor data exterior of the vehicle and may process the captured sensor data to display images and/or to detect objects at or near the vehicle and in the predicted path of the vehicle, such as to assist a driver of the vehicle in maneuvering the vehicle in a rearward direction. The sensing system includes a data processor or data processing system that is operable to receive sensor data from one or more sensors.

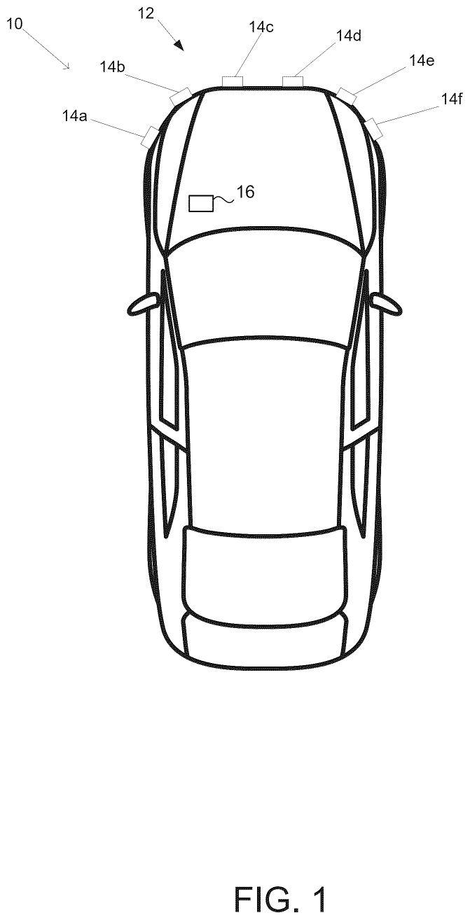

Referring now to the drawings and the illustrative embodiments depicted therein, a vehicle 10 (FIG. 1) includes a driving assistance system or sensing system or ultrasonic sensor system (USS) 12 that includes at least one ultrasonic sensor unit, such as forward facing ultrasonic sensor units 14a-14f (and the system 12 may optionally include multiple exterior facing sensors, such as cameras, radar, or other sensors, such as a rearward facing sensor at the rear of the vehicle 10, and a sideward/rearward facing sensor at respective sides of the vehicle 10, which sense regions exterior of the vehicle 10. In one example, the USS 12 includes a front side left (FSL) sensor 14a, a front outer left (FOL) sensor 14b, a front inner left (FIL) sensor 14c, a front inner right (FIR) sensor 14d, a front outer right (FOR) sensor 14e, and a front side right (FSR) sensor 14f. Additionally or alternatively, the USS 12 may include ultrasonic sensors at other regions of the vehicle, such as at a side or rear of the vehicle. The USS 12 includes a control or electronic control unit (ECU) 16 that includes a data processor that is operable to process data captured by the ultrasonic sensor(s) 14a-f. Each sensor 14a-f may include one or more transmitters that transmit ultrasonic signals (i.e., transmissions) via one or more antennas. Each sensor may also include one or more receivers that receive ultrasonic signals via the antenna(s). The received ultrasonic signals are transmitted ultrasonic signals that are reflected from an object. The ECU or processor is operable to process the received ultrasonic signals to sense or detect the object that the received ultrasonic signals reflected from. The ECU or USS 12 may be part of a driving assist system of the vehicle 10, with the driving assist system controlling at least one function or feature of the vehicle 10 (such as to provide autonomous or semi-autonomous driving control of the vehicle 10) responsive to processing of the data captured by the ultrasonic sensors 14a-14f. The data transfer or signal communication from the sensor to the ECU may comprise any suitable data or communication link, such as a vehicle network bus or the like of the equipped vehicle 10.

When using ultrasonic sensors, sensor calibration improves the reliability of differentiation between actual targets (i.e., objects) and background noise, which minimizes or avoids false identification of targets while maximizing detection sensitivity. Calibration profiles may be estimated by measuring worst-case background noise levels. Existing calibration methods used in automotive systems may inadequately capture complex interactions among sensors and between sensors and the ambient environment, which may result in sub-optimal or reduced detection. Thus, the existing calibration methods may not maximize sensor sensitivity. The existing calibration methods may also involve manual calibration to compensate for false positive identifications. The existing methods leave a need for an approach that includes system considerations, such as field profiles of sensors (i.e., profiles representing fields of sensing of the ultrasonic sensors), key performance indicators (KPIs) for multi-sensor interactions, and temperature-dependent acoustic attenuation.

Accordingly, an automated calibration system and method may increase ultrasonic sensor detection sensitivity and reduce false detections that result from background noise (i.e., false background detections, false positive detections, false identification of targets, etc.) compared to manual calibration. This automated calibration may include an optimization framework to increase sensor calibration performance by optimizing KPIs, maximizing a true positive rate of detection (TPR) while maintaining a false positive rate of detection (FPR) below a predefined threshold. In other words, the optimization framework (i.e., optimization algorithm) of the automated calibration method may maximize TPR at a fixed upper FPR, where TPR is determined by a probability of triangulation p_{Δ}, and FPR is determined by a probability of clutter p_{c}, discussed further below. The automated calibration method may iteratively optimize calibration parameters (e.g., detection threshold parameters) by using gradients of the calibration parameters with respect to the probability of triangulation and the probability of clutter.

An ultrasonic sensor (i.e., an ultrasonic transducer) emits ultrasonic pulses and receives echoes of the ultrasonic pulses when the pulses reflect from objects proximate to the ultrasonic sensor. The USS is calibrated (i.e., tuned) to detect objects or targets in any direction around a vehicle equipped with the USS, providing a field of sensing at least partially surrounding the equipped vehicle (e.g., at least 90 degrees of sensing, at least 180 degrees of sensing, 360 degrees of sensing, etc.). In other words, to optimize detection of objects proximate to the equipped vehicle, the ultrasonic sensors are calibrated such that some or all areas around the vehicle are adequately included in the field of sensing of the USS.

Calibrating the USS involves determining detection threshold parameters. The detection threshold parameters are used to determine whether a detected echo constitutes a valid detection (i.e., a reflection off of an object or target). The detection threshold parameters are a minimum reflection signal amplitude at which the USS determines the detected echo as indicative of an object or target. The USS uses detection threshold parameters to distinguish true object detections from false positive detections caused by random noise or clutter.

Ultrasonic sensors of the USS may have overlapping and/or interacting fields of sensing, which introduces complexity when determining optimal detection threshold parameters. To address this complexity, the overall field profile intensity and the amount of clutter may be input to the calibration method and system. To support this optimization, a transducer model simulates the sensor system's response. Model parameters are calibrated to fit actual transducer measurements, resulting in model parameters representative of real-world operating conditions. Calibrating the model parameters may include determining a comprehensive map of the signal intensities across the entire field of sensing. By modeling interactions among field profiles of the ultrasonic sensors, the automated calibration may determine how overlapping fields of sensing of the ultrasonic sensors affect detection reliability of the USS. Modeling the interactions increases flexibility by allowing adjustment to calibration parameters in static or dynamic sensing conditions, increasing overall accuracy compared to manually calibrating individual sensors in isolation.

The automated calibration implementations for ultrasonic sensors described herein may increase sensor detection sensitivity and decrease false positive detections or false background detections. The calibration may use multi-stage optimization that accounts for field profiles of the sensors, KPIs for multi-sensor interactions, and temperature-dependent acoustic attenuation. In one example, the optimization framework may use an objective function that increases the TPR while maintaining the FPR below a predefined threshold. The calibration may use the transducer model to simulate USS operation and generate model data for true positive detections (i.e., detection and/or identification of targets or objects) and false positive detections (i.e., false identifications of targets or objects). The transducer model may include calibratable parameters that replicate or fit real-world transducer measurements, such that the calibration reflects actual operating conditions. By automating sensor calibration, the calibration improves the efficiency and the accuracy of sensor calibration compared with manual calibration.

The automated calibration models the fields of sensing of the ultrasonic sensors (i.e., the field profiles of the sensors) to accurately determine spatial distribution of the field of sensing of each sensor and to accurately determine interactions between a respective sensor and an object within the field of sensing of the respective sensor. The calibration may use direction cosines, representing both transmission coefficients and object coefficients, and may account for normal vectors of the sensors and objects in the field of sensing. Specifically, the direction cosines are determined by the relative positions of the sensors and the objects, and a transmission coefficient exponent and an object coefficient exponent are used to model the amplitude of signal interactions. Through modeling the field profile, the calibration may account for the geometric characteristics and reflectivity characteristics of both the sensors and the objects, increasing detection accuracy and reliability.

The calibration may include an optimization algorithm that iteratively adjusts calibration parameters to maximize TPR and minimize FPR. The algorithm evaluates a gradient of calibration parameters with respect to a probability of triangulation and a probability of clutter. By using gradient descent or a similar optimization, the optimization algorithm may dynamically determine the sensor detection threshold parameters and other calibratable parameters to determine an optimal calibration. With the calibration, the sensors may have a high sensitivity for true positive detections while suppressing false positive detections caused by background noise, clutter, and/or environmental conditions (e.g., ambient temperature). Accordingly, the optimization algorithm of the calibration may increase sensor performance and robustness of the USS.

The calibration method and system may account for environmental conditions on sensor performance by incorporating temperature-dependent acoustic attenuation into the sensor calibration. The calibration method and system may use empirical data and modeling to simulate the effect of variations in ambient temperature on signal attenuation. For example, a temperature-dependent acoustic attenuation model adjusts the sensor calibration parameters to compensate for changes in signal strength and quality caused by temperature variation. Accordingly, the calibration may determine optimal sensor calibration parameters across a range of ambient temperatures (i.e., operating temperatures), increasing the reliability and the accuracy of the USS.

The calibration method and/or system may include a transducer model that is used to generate inputs (i.e., generate simulated data) that may be used to determine optimization equations for calibration parameters. That is, the transducer model may generate raw data for calibration optimization. The model may simulate operating behavior of the ultrasonic transducer, including the generation of true positive (TP) and false positive (FP) detection signals. The calibration parameters within the transducer model may be calibrated to simulate actual transducer measurements (i.e., simulate the field profile of the sensor), replicating real-world sensor performance. Inputs from the transducer model may also include sensor signal amplitude (represented by a_{r,s}(Xᵢ), discussed below) and background intensity (represented by b_{r,s}(Xᵢ), discussed below), which may be used to describe intensity at position Xᵢ. The raw data produced by the transducer model may be used as input for the optimization algorithm, with which the optimization algorithm may make precise adjustments to the calibration parameters. Thus, with the transducer model, the calibration parameters may be determined based on realistic and reliable data.

The probability of detecting an object at a given position using a receiving sensor and a transmitting sensor (i.e., probability of detection) is represented by Equation (1a), below.

$${p}_{d}^{r s} ( x ) = {\int }_{t = 0}^{∞} {\int }_{a = λ ( t )}^{∞} p ( {\hat{t}}_{r s} ( x ) = t , {a}_{r , s} ( x ) = a ) dadt \qquad ( 1 a )$$

Here, X=(x, y) represents the position of the object in a two-dimensional (2D) vector. The expected amplitude â_{r,s}(X) represents an anticipated signal strength of a signal received by receiving sensor r from transmitting sensor (i.e., source sensor) s. The expected travel time \hat{t}_{r,s}(X) estimates the duration of time for an ultrasonic pulse to travel from the transmitting sensor to the receiving sensor via the object. The probability distribution p(\hat{t}_{r,s}(X)=t, â_{r,s}(X)=a) (i.e., probability density function) represents the expected time-domain signal, modeling an expected amplitude and an expected travel time based on the object's position relative to the sensors. Thus, in Equation (1a), determining

$${p}_{d}^{r , s} ( x )$$

involves integrating the probability of detection over the time-domain variable t, and over relevant amplitudes a that exceed a time-dependent detection threshold λ(t).

The expected amplitude

$${\hat{a}}_{r , s} ( 𝒳 ) ∼ 𝒩 ( {μ}_{a}^{r , s} , {σ}_{a}^{r , s} )$$

and expected travel time

$${\hat{t}}_{r , s} ( 𝒳 ) ∼ 𝒩 ( {μ}_{t}^{r , s} , {σ}_{t}^{r , s} )$$

may be modeled as random variables with a normal Gaussian distribution [symbol] . The parameters

$${μ}_{a}^{r , s} and {μ}_{t}^{r , s}$$

are the mean exPected amplitude and the mean expected travel time, respectively, and

$${σ}_{a}^{r , s} and {σ}_{t}^{r , s}$$

are the corresponding standard deviations of the expected amplitude and the expected travel time, respectively. The expected amplitude and the expected travel time may be determined from Equations (12) and (13) below or measured experimentally (either offline or in real-time), as described below.

The probabilistic formulation of Equation (1a) may be used to determine the likelihood that a received signal amplitude is sufficient for detection or falls within a given time interval at each position X. For any random variable ŷ˜ [symbol] (μ_{y}, σ_{y}), the probability of exceeding a detection threshold λ is

$$p ( \hat{y} \geq λ ) = \frac{1}{2} erf ( \frac{λ - {μ}_{y}}{{σ}_{y} \sqrt{2}} ) ,$$

which is based on the cumulative distribution function (CDF) of a standard normal distribution.

The calibration may calibrate each sensor r by specifying a list of thresholds and/or threshold parameters

$$\{ {λ}_{k}^{r} \} ,$$

indexed by k=1 . . . K and r=1 . . . R, where K is the number of time intervals and R is the number of sensors. In one example, for a detection event to occur, a sensor must receive a signal that has an amplitude that exceeds

$${λ}_{k}^{r}$$

within the time interval tₖ to tₖ₊₁. Formulating the calibration in this manner corresponds to a firmware-level operation of ultrasonic sensors commonly used in vehicles, but the calibration may also be used in more general applications. To optimize thresholds for

$$\{ {λ}_{k}^{r} \} , {p}_{d}^{r , s} ( 𝒳 )$$

may be determined for independent time intervals by dividing the expected probability into discrete bins. Because the probability distribution is assumed to be separable, Equation (1a) may be written as follows:

$$\begin{matrix}{p}_{d}^{r , s} ( 𝒳 ) & = & {\int }_{t = 0}^{∞} [ p ( {\hat{t}}_{r , s} ( 𝒳 ) = t ) {\int }_{a = λ ( t )}^{∞} p ( {\hat{a}}_{r , s} ( 𝒳 ) = a ) da ] dt & ( 1 b ) \\ & = & {\sum }_{k} p ( {t}_{k} \leq {\hat{t}}_{r , s} ( 𝒳 ) \leq {t}_{k + 1} ) p ( {\hat{a}}_{r , s} ( 𝒳 ) \geq {λ}_{k}^{r} ) & ( 1 c ) \\ & & & \end{matrix}$$

### Here

$${p}_{d}^{r , s} ( 𝒳 )$$

depends on the list of thresholds

$$\{ {λ}_{k}^{r} \} .$$

Accordingly, the thresholds

$$\{ {λ}_{k}^{r} \}$$

may be optimized.

In equation (1c), the probability that X is associated with the time interval tₖ to tₖ₊₁ is p(tₖ≤\hat{t}_{r,s} (X)≤tₖ₊₁), where the probability will be non-zero only if the signal travel time \hat{t}_{r,s}(X) (i.e., signal arrival time) is in the time interval tₖ to tₖ₊₁. In one example, by assuming that the timing deviation, corresponding to

$${σ}_{t}^{r , s} ,$$

is small, the travel time \hat{t}_{r,s}(X) coincides with a single time interval, resulting in the summation determining a specific index k. In this example,

$${p}_{d}^{r , s} ( 𝒳 )$$

corresponds to

$$p ( {\hat{a}}_{r , s} ( 𝒳 ) \geq {λ}_{k}^{r} ) ,$$

which determines, the likelihood that the amplitude of the received signal exceeds a single threshold parameter

$${λ}_{k}^{r} .$$

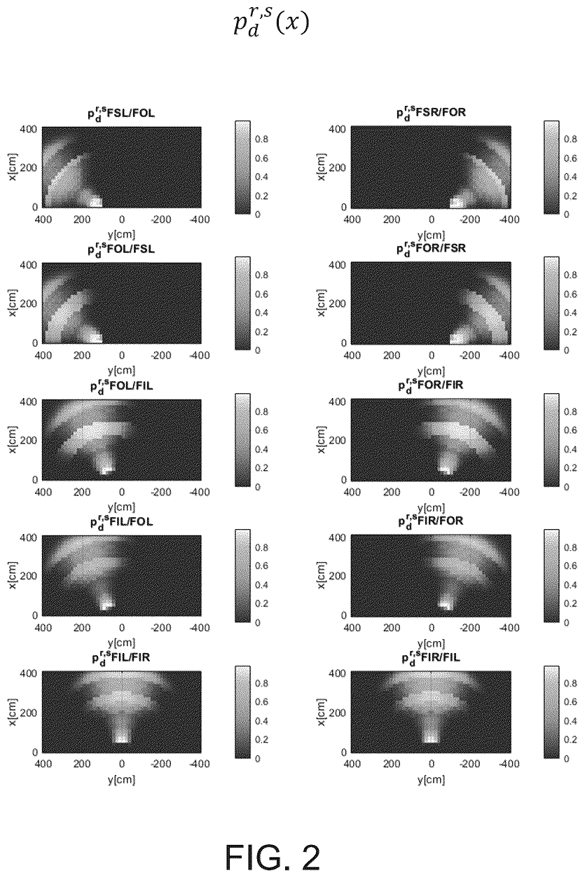

FIG. 2 illustrates spatial maps of probability of detection

$${p}_{d}^{r , s} ( 𝒳 ) ,$$

determined for various pairs of sensors of the front bumper of the equipped vehicle. The sensors include FSL sensor 14a, FSR sensor 14f, FOL sensor 14b, FOR sensor 14e, FIL sensor 14c, and FIR sensor 14d.

The probability of a false background detection

$${p}_{b}^{r , s} ( 𝒳 )$$

associated with position X using receiving sensor r from transmitting sensor s is represented by Equation (2), below.

$${p}_{b}^{r , s} ( 𝒳 ) = {\sum }_{k} p ( {t}_{k} \leq {\hat{t}}_{r s} ( 𝒳 ) \leq {t}_{k + 1} ) p ( {\hat{b}}_{r , s} ( 𝒳 ) \geq {λ}_{k}^{r} ) \qquad ( 2 )$$

As in Equation (1c), the probability that X is associated with the time interval tₖ to tₖ₊₁ is p(tₖ≤\hat{t}_{r,s}(X)≤tₖ₊₁). The expected background noise level (i.e., background intensity) is a normally distributed random variable

$${\hat{b}}_{r s} ( 𝒳 ) ∼ 𝒩 ( {μ}_{b}^{r , s} , {σ}_{b}^{r , s} ) .$$

Variable \hat{b}_{r,s}(X) may be determined by Equation (17a), discussed below. As indicated in Equation (2),

$${p}_{b}^{r , s} ( 𝒳 )$$

depends on

$$p ( {\hat{b}}_{r , s} ( 𝒳 ) \geq {λ}_{k}^{r} ) ,$$

the probability that \hat{b}_{r,s}(X) exceeds

$${λ}_{k}^{r} .$$

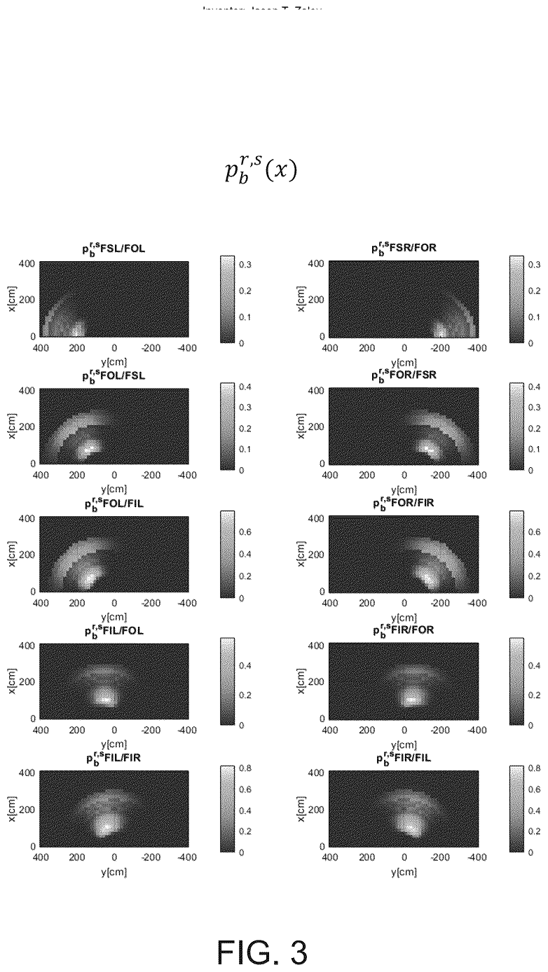

Physically, a false background detection is the susceptibility of a sensor to ambient noise or signals other than a signal reflected by a target object. High probabilities of a false background detection may reduce the effectiveness of the sensor and lead to false positive detections, where the USS interprets non-target signals as true positive detections. FIG. 3 illustrates spatial maps of the probability of a false background detection

$${p}_{b}^{r , s} ( 𝒳 ) ,$$

determined for various pairs of sensors of the front bumper of the equipped vehicle. Under operating conditions, reflections from the road surface or the ground along which the equipped vehicle is traveling may contribute to background noise. For example, smooth or rough surfaces, such as asphalt, cobblestone, or gravel, in combination with sensor height, sensor angles, and sensor field-of-view, can affect the interference caused by ground reflections.

To localize a position of an object, a pair of sensors triangulate the position of the object using the known sensor positions and the travel times of the echoes received by the sensors. The probability of triangulation

$${p}_{Δ}^{r , s} ( 𝒳 )$$

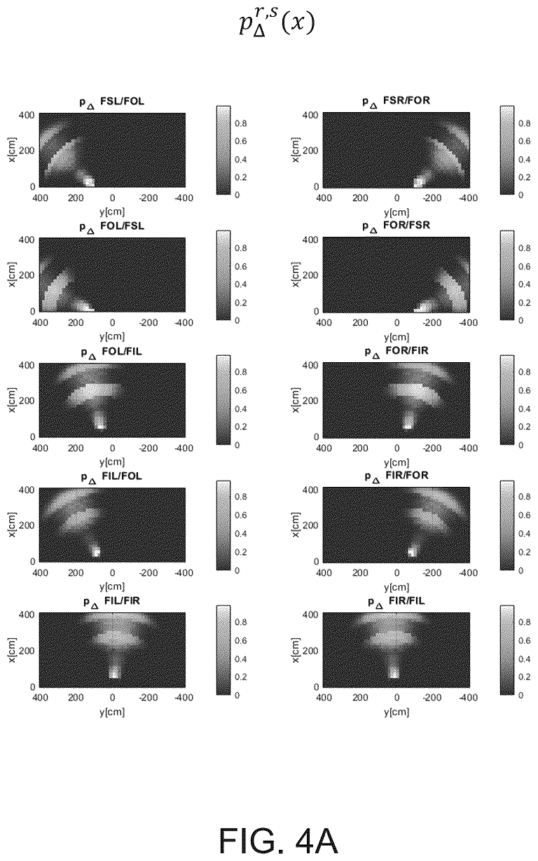

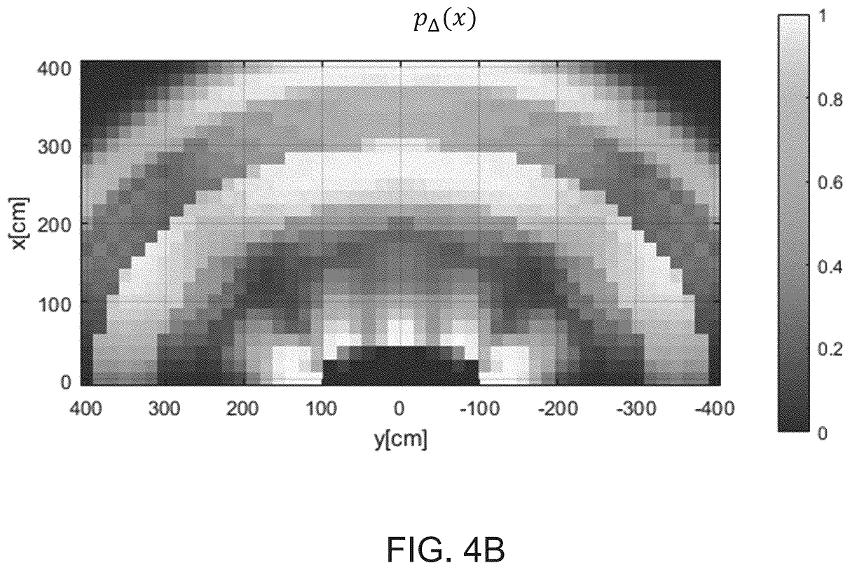

represents the likelihood of a correct detection of an object at position X using a pair of sensors r and s. Triangulation may include a pair of signal detections: (1) a direct detection

$${p}_{d}^{s , s} ( 𝒳 ) ,$$

where the same sensor s both transmits and receives the signal, and (2) an indirect detection

$${p}_{d}^{r , s} ( 𝒳 ) ,$$

where one sensor s transmits the signal and another sensor r receives the signal. In one example, sensor r and sensor s may both receive the same signal sent by sensor s, resulting in simultaneous direct and indirect detections. The overall probability of triangulation includes triangulation by at least one pair of sensors. FIG. 4A illustrates spatial maps of the probability of triangulation

$${p}_{Δ}^{r , s} ( 𝒳 ) ,$$

determined for various pairs of sensors of the front bumper of the equipped vehicle. In the transducer model,

$${p}_{Δ}^{r , s} ( 𝒳 )$$

requires that the direct detection and the indirect detection are both received, as represented by Equation (3), below.

$${p}_{Δ}^{r , s} ( 𝒳 ) = {p}_{d}^{s , s} ( 𝒳 ) {p}_{d}^{r , s} ( 𝒳 ) \qquad ( 3 )$$

The USS may perform triangulation from any combination of pairs of sensors. The overall probability of triangulation (i.e., overall probability of detection) p_{Δ}(X) may be determined by combining the detection probabilities of various sensor combinations (rⱼ, sⱼ) of a firing sequence S, as represented by Equation (4), below.

$${p}_{Δ} ( 𝒳 ) = 1 - [ {\prod }_{( {r}_{j} , {s}_{j} ) ∈ S} ( 1 - {p}_{Δ}^{{r}_{j} , {s}_{j}} ( 𝒳 ) ) ] \qquad ( 4 )$$

Equation (4) includes a union of detection probabilities across various sensor combinations, which takes into account that even if one pair of sensors fails to detect a signal, other pairs may successfully detect the signal. Here

$$( 1 - {p}_{Δ}^{{r}_{j} , {s}_{j}} ( 𝒳 ) )$$

represents the probability of non-triangulation for the pair of sensors(rⱼ, sⱼ), and

$${\prod }_{( {r}_{j} , {s}_{j} ) ∈ S} ( 1 - {p}_{Δ}^{{r}_{j} , {s}_{j}} ( 𝒳 ) )$$

represents the probability of non-triangulation for all pairs of sensors. The union uses a product term to aggregate individual detection failures, and the complement provides the overall success rate in detecting the object X through triangulation. FIG. 4B illustrates a spatial map of the overall probability of triangulation p_{Δ}(X), determined for the USS of the equipped vehicle.

The probability of clutter p_{c}(x) represents the likelihood that the sensors detect signals from non-target objects or environmental noise (i.e., clutter) rather than the target object at position X. Determining the probability of clutter affects the accuracy and reliability of the USS. The probability of clutter is represented by Equation (5), below.

$${p}_{c} ( 𝒳 ) = {p}_{i n t} ( 𝒳 ) + ( 1 - {p}_{i n t} ( 𝒳 ) ) {\overbrace{( 1 - [ {\prod }_{( {r}_{j} , {s}_{j} ) ∈ S} ( 1 - {p}_{β}^{{r}_{j} , {s}_{j}} ( 𝒳 ) ) ] )}}^{{p}_{β} ( 𝒳 )} \qquad ( 5 )$$

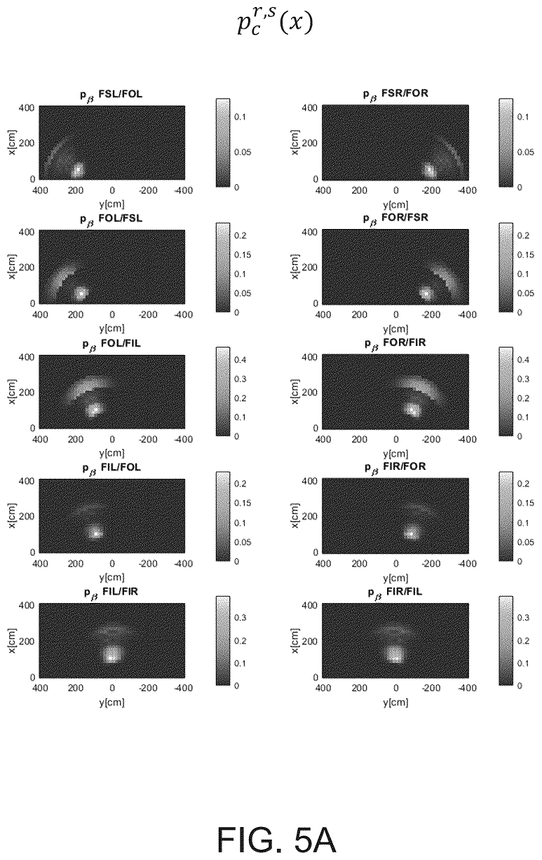

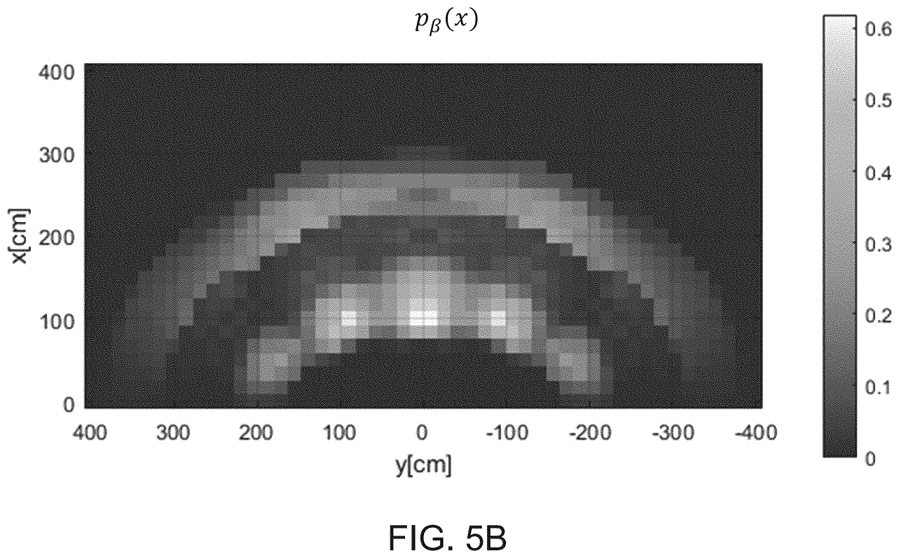

Here, the probability of interference pᵢₙₜ(X) is the likelihood that signals from various sources lead to false positive detections associated with position X. Interference may be caused by multiple overlapping reflections, environmental conditions, signals from adjacent sensors, etc. The interference is considered separately from triangulated background reflections, as (1−pᵢₙₜ(X)) represents the clutter component where interference does not occur. Interference pᵢₙₜ(X) may be assumed not to impact the gradient of threshold parameters. Thus, p_{c}(X)=p_{β}(X). FIG. 5A illustrates spatial maps of the probability of clutter

$${p}_{c}^{r , s} ( 𝒳 ) ,$$

determined for various pairs of sensors of the front bumper of the equipped vehicle.

In Equation (5), the overall probability of triangulating a false detection p_{β}(X) represents the likelihood that sensors detect and triangulate background noise rather than the target object. The overall probability of triangulating a false detection corresponds to any pair of sensors (rⱼ, sⱼ) in the firing sequence S producing a false triangulation. FIG. 5B illustrates the overall probability p_{β}(X) that the USS triangulates a false detection. A pair of sensors triangulating a false detection

$${P}_{β}^{r , s} ( 𝒳 )$$

depends on the probability of triangulation from false direct detections and indirect detections, represented by Equation (6), below.

$${p}_{β}^{r , s} ( 𝒳 ) = {p}_{b}^{s , s} ( 𝒳 ) {p}_{b}^{r , s} ( 𝒳 ) \qquad ( 6 )$$

The TPR measures the proportion of target objects correctly detected by the sensors, represented by Equation (7a), below.

$$T P R = \frac{T P}{T P + F N} = 1 - F N R = \frac{{\sum }_{i} {p}_{Δ} ( {𝒳}_{i} ) {w}_{i}^{T P}}{{\sum }_{i} {w}_{i}^{T P}} \qquad ( 7 a )$$

Here, TP represents the number of true positive detections and FN represents the number of false negative detections, or the number of instances in which the USS fails to detect a target object. FNR represents the false negative rate. TPR is determined according to the overall triangulation performance p_{Δ}(Xᵢ) of Equation (4) at each object position Xᵢ for i=1 . . . N, where N is the number of object positions. That is, TPR is defined by the probability of triangulation.

Since performance requirements may differ spatially, a weighted parameter (i.e., weighting factor) wᵢ^{TP} may be associated with each object position Xᵢ, where wᵢ^{TP} specifies the relative performance requirement. Weighted parameters permit different object positions to have unequal weight or unequal importance to the overall performance rate of the USS. In one example, a design consideration of the USS may be that detecting objects located diagonally or next to the equipped vehicle, i.e., not directly in front of the vehicle, should be prioritized over detecting objects located directly in front of the equipped vehicle and therefore directly in a driver's line of sight. Accordingly, object positions diagonal or next to the equipped vehicle may receive a higher weighted parameter than object positions directly in front of the vehicle. In another example, a design consideration of the USS may be that detecting objects located directly in front of the vehicle should be prioritized over objects next to or adjacent to the equipped vehicle, as the equipped vehicle is more likely to collide with objects directly in front of it. Accordingly, object positions directly in front of the equipped vehicle may receive a higher weighted parameter than objects positioned diagonal or adjacent to the equipped vehicle.

The FPR represents false positive detections, determining the proportion of non-target objects incorrectly identified as target objects by the USS. That is, FPR is defined by the probability of clutter. The FPR is represented by Equation (7b), below.

$$F P R = \frac{F P}{F P + T N} = 1 - T N R = \frac{{\sum }_{i} {p}_{c} ( {𝒳}_{i} ) {w}_{i}^{F P}}{{\sum }_{i} {w}_{i}^{F P}} \qquad ( 7 b )$$

Here, FP represents the number of false positive detections. The variable TN represents the number of true negative determinations, where a true negative determination occurs when the sensors correctly determine that a perceived reflection, background noise, or clutter is not a target object. The variable TNR is the true negative rate, where TNR is determined according to the probability of clutter p_{c}(Xᵢ) of equation (5) at each object position Xᵢ for i=1 . . . N. A weighted parameter

$${w}_{i}^{F P}$$

is associated with each object position Xᵢ, where

$${w}_{i}^{F P}$$

specifies the relative performance requirement at each position Xᵢ. Both TPR and FPR indicate sensor performance, and the calibration may be used to maximize TPR for effective detection and minimize FPR to reduce false positive detections.

Sensor and USS calibration may include an optimization algorithm to adjust system parameters to meet optimization objectives. In one example, an optimization objective may be expressed by an optimization equation, such as Equation (8), below.

$$maximize TPR ( λ ) subject to FPR ( λ ) \leq α \qquad ( 8 )$$

Here, TPR(λ) and FPR(λ) depend on parameter λ, where λ corresponds to sensor thresholds and calibration parameters, according to Equations (7a) and (7b). Parameter α represents a predefined acceptable FPR (i.e., FPR threshold). In the optimization equation, parameter α constitutes an input, and parameter λ constitutes an output to determine. Other optimization objectives may be applied to the calibration. For example, another optimization objective may include minimizing FPR(λ) subject to TPR(λ)>α where α is a predefined acceptable TPR (i.e., a TPR threshold).

An optimization equation, such as Equation (8), may be expressed by an objective function and a constraint function, such as represented in Equation (9), below.

$$minimize f ( λ ) subject to g ( λ ) \leq 0 \qquad ( 9 )$$

Here, ƒ(λ) represents the objective function and g(λ) represents the constraint function. In one example, ƒ(λ)=1−TPR(λ) and g(λ)=FPR(λ)−α. A linear approximation of ƒ(λ) and g(λ) may be used to solve Equation (9), such as the linear approximation represented by Equations (10a) and (10b), below.

$$f ( λ + Δ λ ) \approx f ( λ ) + {[ ∇ f ( λ ) ]}^{T} Δλ \qquad ( 10 a )$$

$$g ( λ + Δ λ ) \approx g ( λ ) + {[ ∇ g ( λ ) ]}^{T} Δλ \qquad ( 10 b )$$

Here, ∇ƒ(λ) is an objective function gradient and ∇g(λ) is a constraint function gradient, and Δλ is a change of λ.

The augmented Lagrangian method may be used to accommodate constraints in optimization equations. Augmented Lagrangian function L_{A}(λ+Δλ, μ, ρ) incorporates penalty terms for constraint violations, which improves convergence characteristics. Here, μ is a Lagrange multiplier, and ρ is a penalty parameter. The augmented Lagrangian function may be solved with Equation (11), below.

$${L}_{A} ( λ + Δ λ , μ , ρ ) = f ( λ ) + \frac{ρ}{2} {g ( λ )}^{2} + {[ ∇ f ( λ ) + ( μ + ρ g ( λ ) ) ∇ g ( λ ) ]}^{T} Δ λ \qquad ( 11 )$$

In one example, an iterative algorithm (i.e., the augmented Lagrangian method) may be used to minimize Equation (11) as follows:

| | |
|---|---|
| 1. | For n = 0 to N, do: |
| 2. | η⁽ⁿ⁺¹⁾←λ⁽ⁿ⁾ − ∇f(λ⁽ⁿ⁾) − μ⁽ⁿ⁾∇g(λ⁽ⁿ⁾) |
| 3. | ${λ}^{( n + 1 )} ← {η}^{( n + 1 )} + \frac{n}{n + 3} ( {η}^{( n + 1 )} - {η}^{( n )} )$ |
| 4. | μ⁽ⁿ⁺¹⁾←μ⁽ⁿ⁾ + ρ⁽ⁿ⁾ max (0,g(λ⁽ⁿ⁾)) |
| 5. | ρ⁽ⁿ⁺¹⁾←ρ⁽ⁿ⁾ (1 + step(g(λ⁽ⁿ⁾))) |
| 6. | end for |

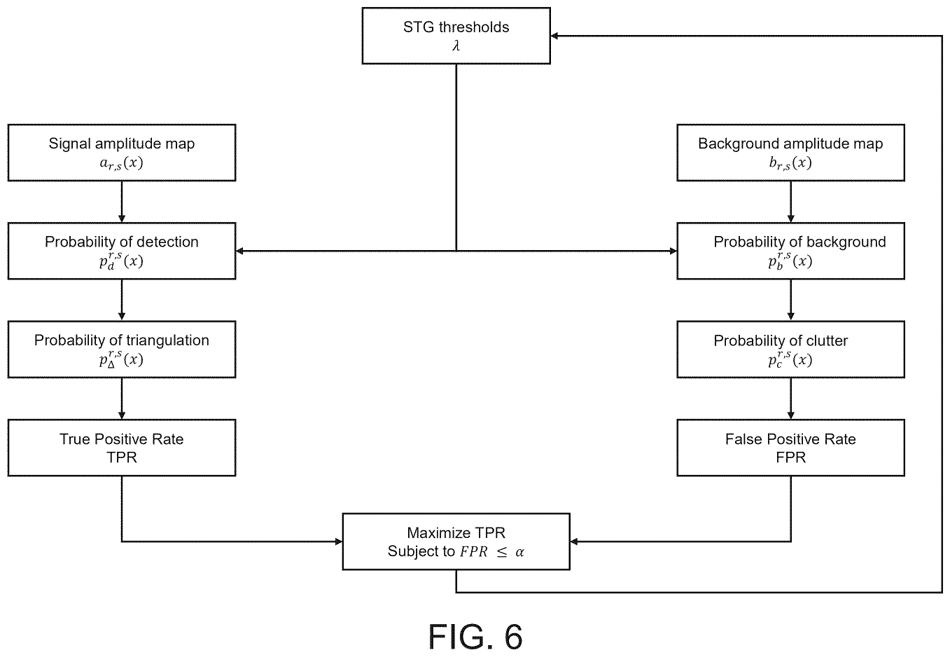

The algorithm begins with an initialization, using an initial guess λ⁽⁰⁾, Lagrange multiplier μ⁽⁰⁾, and penalty parameter ρ⁽⁰⁾. N iterations of the algorithm may be used to solve the augmented Lagrangian function. In the n^{th} iteration, the parameters ηⁿ⁺¹, λⁿ⁺¹, μⁿ⁺¹ and ρⁿ⁺¹ are updated as shown. The algorithm may refine the sensor thresholds λ and other calibration parameters to balance the objective of maximizing TPR while maintaining the constraint requirement for FPR. The augmented Lagrangian method includes penalty terms to handle constraint violations, facilitating convergence. The augmented Lagrangian method may refine sensor calibrations for optimized performance, increasing the detection accuracy and the reliability of the USS. FIG. 6 illustrates a block diagram of determining TPR and FPR to refine the calibration parameter λ.

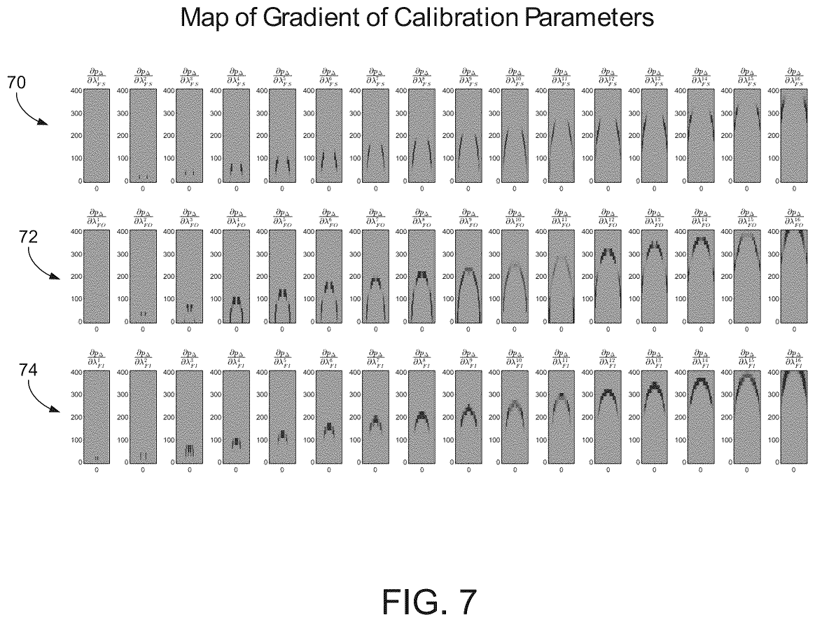

In each iteration of the algorithm, the gradients ∇ƒ(λ) and ∇g(λ) are determined. FIG. 7 is a graphical map of the gradient

$$∇ f ( λ ) = \frac{\partial {p}_{Δ} ( X )}{\partial λ} .$$

The map indicates how each parameter

$${λ}_{k}^{r}$$

affects the probability of triangulation and TPR. The map includes three parameter sets: front side (FS) parameter set 70 in the top row, front outer (FO) parameter set 72 in the middle row, and front inner (FI) parameter set 74 in the bottom row. Each parameter set includes sixteen sensor threshold gradients (STG) parameters.

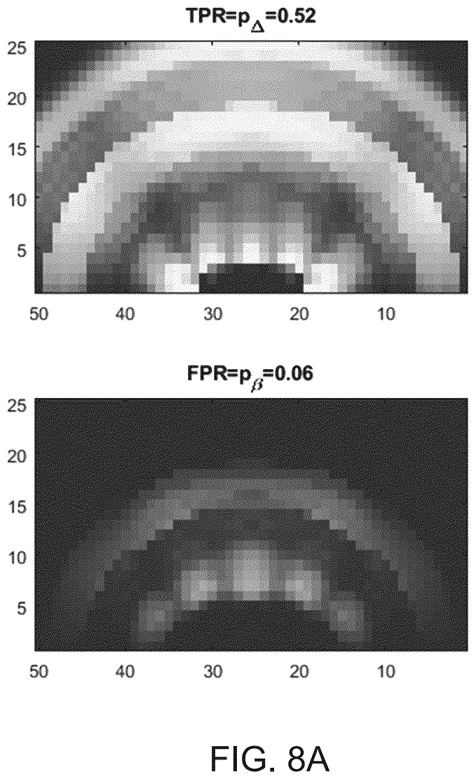

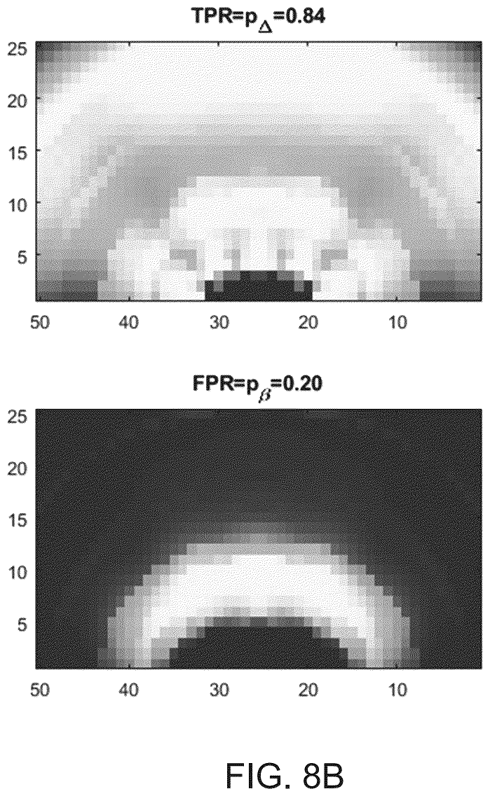

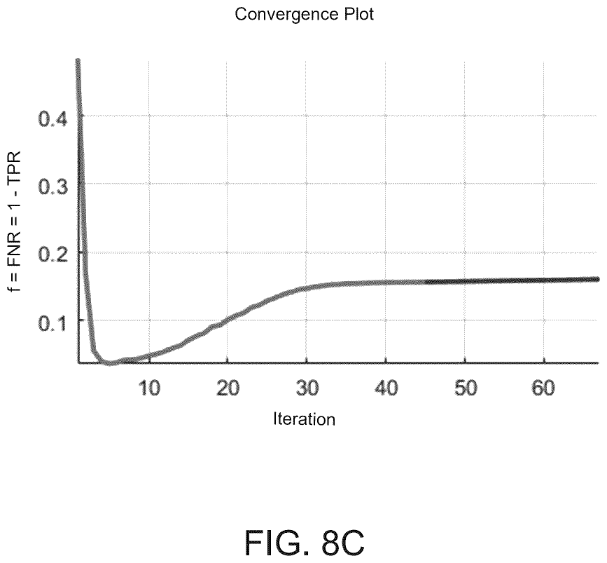

FIGS. 8A-8C illustrate how iteratively calibrating the USS according to the calibration realizes the optimization objective. FIG. 8A illustrates an example spatial map of a TPR and an FPR of a USS with an initial calibration performed through manual calibration. The initial calibration yields a TPR of 0.52 and an FPR of 0.06. FIG. 8B illustrates the spatial map after the USS has been calibrated using the optimization algorithm according to the calibration method and system, resulting in an increased TPR of 0.84 and an FPR of 0.20. The overall FPR has been constrained to FPR≤α=0.20. The automated process of the calibration determines an optimized calibration for a fixed FPR. FIG. 8C illustrates a graph of the convergence of the FNR across iterations of the algorithm, where f=FNR=1−TPR is plotted as a function of each iteration. Feasibility of the USS is realized when FPR≤α, which occurs after forty-five iterations.

Signal amplitude of the ultrasonic sensors of the USS affect the probability of detection, the probability of triangulation, and TPR. The modeled expected signal amplitude a_{r,s}(Xᵢ) represents the strength (i.e., amplitude) of an ultrasonic signal received by sensor r after being transmitted from sensor s and reflecting off of an object at position Xᵢ. The modeled expected amplitude is represented by Equation (12), below.

$${a}_{r , s} ( {X}_{i} ) = {α}_{i} \frac{( {X}_{i} ) ( {X}_{i} )}{{t}_{r , s} ( {X}_{i} )} {A}_{\frac{dB}{m}} ( {t}_{r , s} ( {X}_{i} ) ) {G}_{STC} ( {t}_{r , s} ( {X}_{i} ) ) \qquad ( 12 )$$

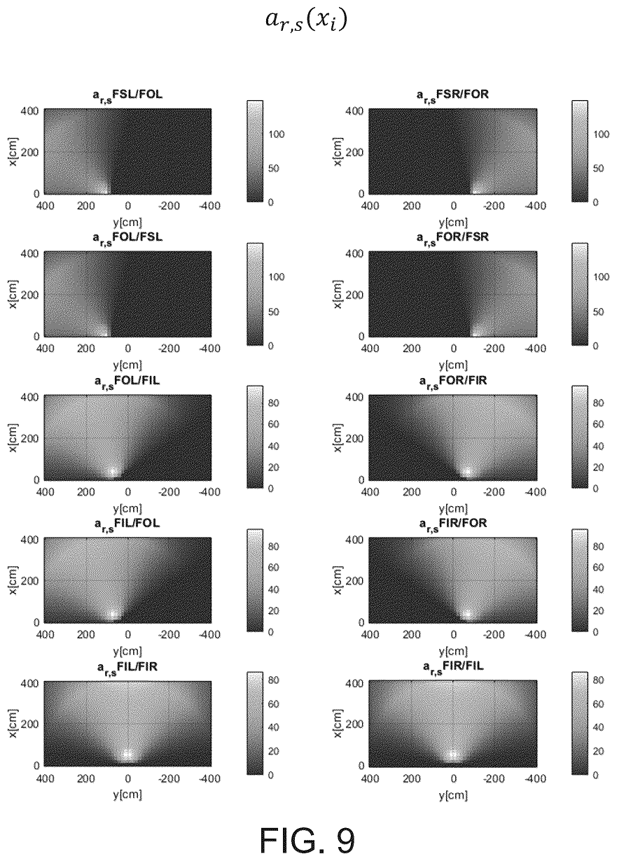

The amplitude may be affected by aspects of the USS, including the positions of the sensors and the relative orientation of the sensors. The amplitude may also be affected by conditions including the position of the object, the size of the object, the shape of the object, surfaces of the object, materials of the object, reflectivity of the object, ambient temperature, background noise, other environmental conditions, etc., as described further below. FIG. 9 illustrates spatial maps of amplitude a_{r,s}(Xᵢ) for the pair of sensors r and s, determined for various pairs of sensors of the front bumper of the equipped vehicle. The constant αᵢ of Equation (12) represents the acoustic reflectivity (i.e., acoustic strength parameter) of the object at position Xᵢ. A higher reflectivity results in a stronger received signal. The travel time t_{r,s}(Xᵢ) represents the time of arrival of the signal transmitted from sensor s to sensor r via reflection from the object at Xᵢ, as represented by Equation (13), below.

$${t}_{r , s} ( {X}_{i} ) = \frac{1}{{c}_{o}} ( ‖ {X}_{i} - {X}_{r} ‖ + ‖ {X}_{i} - {X}_{s} ‖ ) \qquad ( 13 )$$

Here, Xᵣ represents the known position of receiving sensor r and Xₛ represents the known position of transmitting sensor s. The constant cₒ is the speed of sound.

The spatial field profiles [symbol] (Xᵢ) and [symbol] (Xᵢ) of sensors r and s represent the interaction of the sensors with the object, which is represented by Equation (14), below.

$$( {X}_{i} ) = \frac{{\vert {\tilde{n}}_{j} \cdot ( {X}_{i} - {X}_{j} ) \vert}^{{k}_{t}} {\vert {\hat{n}}_{i} \cdot ( {X}_{i} - {X}_{j} ) \vert}^{{k}_{o}}}{{‖ {X}_{i} - {X}_{j} ‖}^{{k}_{o} + {k}_{t}}} = {cos ( {θ}_{j} )}^{kt} {cos ( {θ}_{i} )}^{{k}_{o}} \qquad ( 14 )$$

Because the spatial field profile is the same for the receiving sensor and the transmitting sensor, [symbol] (X) may represent either [symbol] (Xᵢ) or [symbol] (Xᵢ) in Equation (12). The spatial field profile captures the amplitude of interactions between a sensor at position Xⱼ and the object at position Xᵢ. The profile involves direction cosines cos(θⱼ) and cos(θᵢ), which represent the orientation of the sensors and the object normals, respectively, relative to a connecting line. The transducer directionality coefficient kₜ and the object directionality coefficient kₒ model the respective contributions of sensor transmission and object reflectivity, respectively. The orientations of the sensor and the object, represented by normals \hat{n}ⱼ j and \hat{n}ᵢ, respectively, influence the strength of the interaction of the sensor with the object.

The atmospheric attenuation factor

$${A}_{\frac{dB}{m}} ( t )$$

of Equation (12) quantifies signal loss (i.e., attenuation) as the signal travels through a medium, represented by Equation (15a).

$${A}_{\frac{dB}{m}} ( t ) = {e}^{- {α}_{\frac{dB}{m}} \frac{ln ( 10 )}{20} {c}_{o} t} \qquad ( 15 a )$$

### Here,

$${α}_{\frac{dB}{m}}$$

is empirically fitted based on temperature T, in Celsius, as represented in Equation (15b), below.

$${α}_{\frac{dB}{m}} ≅ 0.7 arctan ( \frac{T - 15}{10} ) + 1.3 \qquad ( 15 b )$$

Signal attenuation is also affected by humidity, air pressure, and acoustic frequency. The signal time compensation (STC) function G_{STC}(t) adjusts for time-dependent attenuation that results from electronics and processing during acquisition. The STC function is represented by Equation (16), below.

$${G}_{STC} ( t ) ≅ min ( {k}_{1}^{STC} , exp [ {k}_{2}^{STC} max ( 0 , min ( {k}_{3}^{STC} , \frac{{c}_{o} t}{2} - {k}_{4}^{STC} ) ) ] ) \qquad ( 16 )$$

$${k}_{1}^{STC} = 15 , {k}_{2}^{STC} = 0.84 , {k}_{3}^{STC} = 3.3 , {k}_{4}^{STC} = 1 m$$

### Here

$${k}_{1}^{STC} , {k}_{2}^{STC} , {k}_{3}^{STC} , and {k}_{4}^{STC}$$

are empirically determined constants.

Background intensity b_{r,s}(X) represents environmental conditions or noise that may cause the USS to determine a false positive detection or a false negative detection. Environmental conditions or noise may include reflections of the signal off the ground, a road, or any surface on which the equipped vehicle is traveling. Environmental conditions may also include ambient temperature, background noise, signals of other systems, etc. The background intensity is represented by Equations (17a) and (17b), below.

$${b}_{r , s} ( X ) = \frac{{α}_{g} {A}_{\frac{dB}{m}} {G}_{STC}}{{t}_{r , s} ( X )} {\int }_{{t}_{r , s} ( {X}_{i} ) = {t}_{r , s} ( X )} {{[ cos ( {θ}_{r} ) cos ( {θ}_{s} ) ]}^{{k}_{t}} [ cos ( {ϕ}_{r} ) cos ( {ϕ}_{s} ) ]}^{{k}_{z} + {k}_{g}} d {X}_{i} \qquad ( 17 a )$$

$$\approx \frac{{α}_{g} {A}_{\frac{dB}{m}} {G}_{STC}}{{t}_{r , s} ( X )} cos {{( {θ}_{r} )}^{{k}_{t}} [ cos ( {ϕ}_{r} ) cos ( {ϕ}_{s} ) ]}^{{k}_{z}} max {( 0 , \frac{{{t}_{r , s} ( X )}^{2} - {( {z}_{r} + {z}_{s} )}^{2} / {c}_{0}^{2}}{{{t}_{r , s} ( X )}^{2} + {( {z}_{r} + {z}_{s} )}^{2} / {c}_{0}^{2}} )}^{{k}_{g}} \qquad ( 17 b )$$

In Equation (17a), the reflected intensity is integrated along a curve Xᵢ of locations with equal travel time to position X. The reflected intensity accounts for any background reflections that interfere with position X. In equation (17b), the integral of Equation (17a) is approximated by an analytical expression.

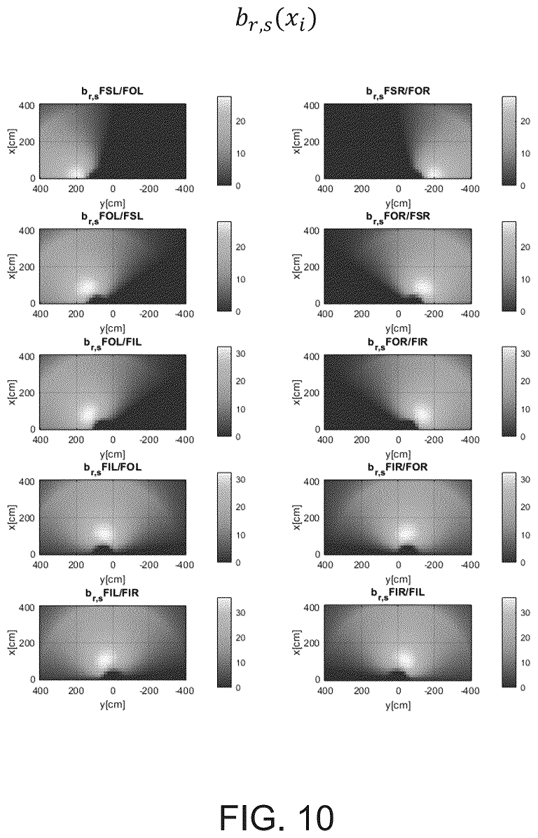

FIG. 10 illustrates spatial maps of background intensity b_{r,s}(X) determined for various pairs of sensors of the front bumper of the equipped vehicle. In Equations (17a) and (17b), t_{r,s}(X),

$${A}_{\frac{dB}{m}} ( X ) ,$$

and G_{STC}(t) correspond to Equations (13), (15a), and (16), respectively. Constants k_{g}, a ground specular reflection parameter, and α_{g} modulate how ground reflection influences the signal strength. The vertical directionality constant k_{z} (i.e., transducer vertical directionality parameter) modulates the vertical component of the field profile's intensity. Constant kₜ represents the transducer horizontal directionality parameter. The angle relative to the ground is φⱼ. The cosine of φⱼ is represented by Equation (18a), below.

$$cos ( {ϕ}_{j} ) = \frac{\vert {z}_{i} - {z}_{j} \vert}{‖ ( {x}_{i} - {x}_{j} , {z}_{i} - {z}_{j} ) ‖} \qquad ( 18 a )$$

The direction cosine cos(θⱼ), where j=r or j=s, is the angle of object Xᵢ relative to the sensor with respect to the normal \hat{n}ⱼ of the sensor, represented by Equation (18b), below.

$$cos ( {ϕ}_{j} ) = \frac{\vert {\hat{n}}_{j} \cdot ( {x}_{i} - {x}_{j} ) \vert}{‖ ( {x}_{i} - {x}_{j} ) ‖} \qquad ( 18 b )$$

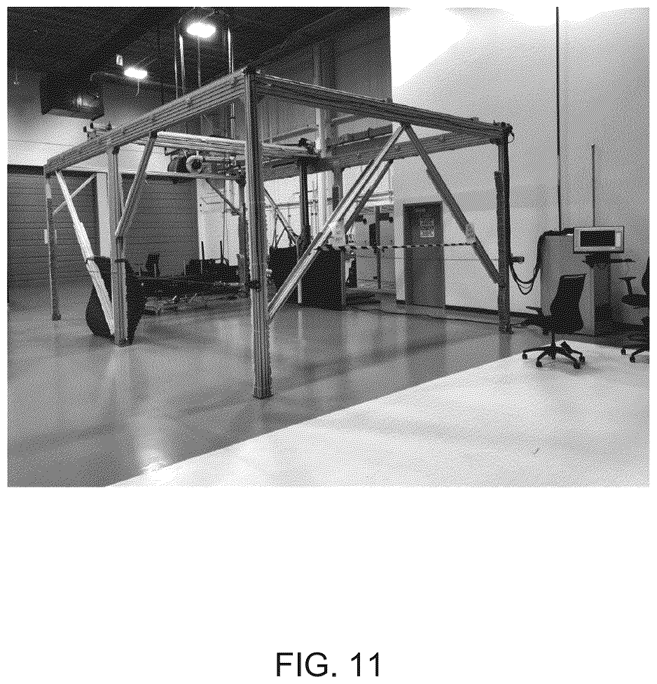

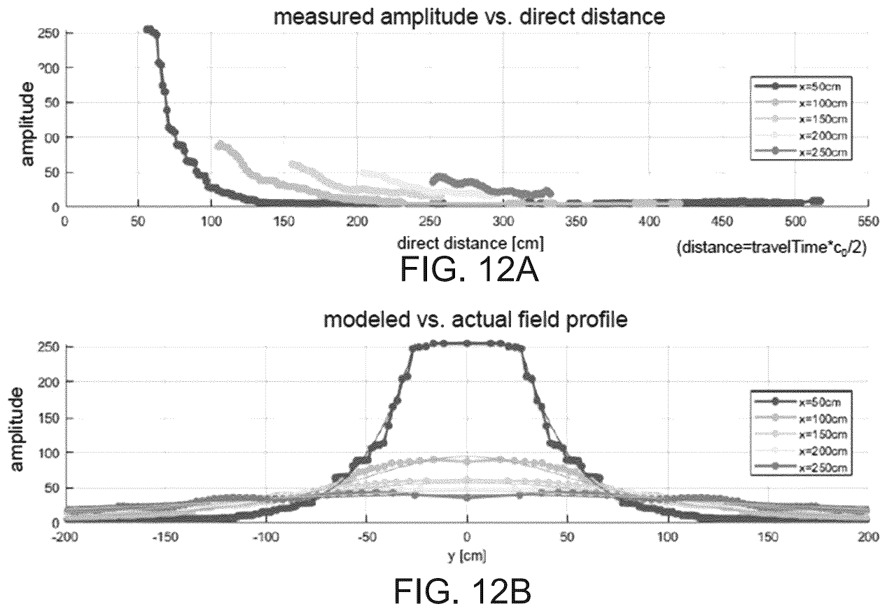

To compare modeled sensor performance, determined using Equation (12), with actual, measured sensor performance, experimental data may be collected using a mapping station, which is exemplified in FIG. 11. Here, a USS measures a direct distance of a vertical pole from the USS and the amplitude of a signal reflected by the pole. In one example, the vertical pole may have a 70 mm diameter and may be positioned at various positions recorded in 2D coordinates. FIG. 12A illustrates example sensor measurements of the direct distance of the pole and the amplitude of the reflected signal. FIG. 12B illustrates an example graph of a modeled field profile, represented by solid lines, compared with an actual field profile, represented by lines with dotted markers. The modeled field profile was determined using a_{r,s}(Xᵢ) of Equation (12). The actual field profile was determined with data collected using a USS fitted to a vehicle bumper in the mapping station.

Although the calibration methods and systems discussed herein have been described with respect to calibrating ultrasonic sensor systems, the calibration may be used to calibrate other sensing systems that rely on reflecting signals off of objects, including radar systems, lidar systems, etc. Additionally, although the calibration has been described with respect to calibrating ultrasonic sensors located along a front bumper of an equipped vehicle, the calibration may be used to calibrate sensors located in other locations around the vehicle, including the rear bumper, sides, side panels, quarter panels, etc. The calibration may also be used to calibrate sensing systems used in contexts other than automotive contexts.

The calibration methods and systems discussed herein may be implemented and/or executed and/or performed at any stage of design, manufacture, or operation of an ultrasonic sensing system. In one example, the calibration may be performed during the design of an ultrasonic sensing system. In another example, the calibration may be performed during the manufacture of a vehicle or any device including an ultrasonic sensing system. In a further example, the calibration may be performed by an ultrasonic sensing system of a vehicle while a driver is driving the vehicle or during a diagnostic cycle performed by an ECU of the vehicle. The driver may initiate the calibration, or the vehicle may automatically perform the calibration as part of a diagnostic schedule or when a set of conditions are met that indicate to the ECU to calibrate the vehicular ultrasonic sensing system.

The vehicle may include any type of sensor or sensors, such as imaging sensors or radar sensors or lidar sensors or ultrasonic sensors or the like. The imaging sensor of the camera may capture image data for image processing and may comprise, for example, a two-dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular ultrasonic sensing system, the vehicular ultrasonic sensing system comprising:
a plurality of ultrasonic sensors disposed at a vehicle equipped with the vehicular ultrasonic sensing system, wherein each ultrasonic sensor of the plurality of ultrasonic sensors senses exterior of the vehicle, and wherein each ultrasonic sensor of the plurality of ultrasonic sensors is operable to capture sensor data;
an electronic control unit (ECU) having electronic circuitry and associated software;
wherein sensor data captured by each sensor is transferred to the ECU;
wherein the electronic circuitry of the ECU comprises a processor, and wherein the processor is operable to process sensor data captured by each ultrasonic sensor of the plurality of ultrasonic sensors and transferred to the ECU;
wherein, for each respective ultrasonic sensor of a pair of ultrasonic sensors of the plurality of ultrasonic sensors, the vehicular ultrasonic sensing system determines, based on processing at the ECU of sensor data captured by the respective ultrasonic sensor, a probability that the respective ultrasonic sensor of the pair of ultrasonic sensors correctly detects an object that is present within a field of sensing of the respective ultrasonic sensor;
wherein, for each respective ultrasonic sensor of the pair of ultrasonic sensors of the plurality of ultrasonic sensors, the vehicular ultrasonic sensing system determines, based on processing at the ECU of sensor data captured by the respective ultrasonic sensor, a probability that the respective ultrasonic sensor of the pair of ultrasonic sensors incorrectly detects an object that is not present within the field of sensing of the respective ultrasonic sensor; and
wherein the vehicular ultrasonic sensing system is calibrated based at least in part on (i) the determined probability that each ultrasonic sensor of the pair of ultrasonic sensors correctly detects an object and (ii) the determined probability that each ultrasonic sensor of the pair of ultrasonic sensors incorrectly detects an object.

2. The vehicular ultrasonic sensing system of claim 1, wherein the pair of ultrasonic sensors have overlapping fields of sensing.

3. The vehicular ultrasonic sensing system of claim 1, wherein calibrating the vehicular ultrasonic sensing system comprises determining a value of a calibration parameter of at least one ultrasonic sensor of the pair of ultrasonic sensors.

4. The vehicular ultrasonic sensing system of claim 3, wherein determining the value of the calibration parameter comprises determining the value of the calibration parameter that causes the probability that each ultrasonic sensor of the pair of ultrasonic sensors correctly detects an object to exceed a threshold value, and wherein determining the value of the calibration parameter comprises using an objective function that minimizes the probability that each ultrasonic sensor of the pair of ultrasonic sensors incorrectly detects an object.

5. The vehicular ultrasonic sensing system of claim 3, wherein determining the value of the calibration parameter comprises determining the value of the calibration parameter that causes the probability that each ultrasonic sensor of the pair of ultrasonic sensors incorrectly detects an object to not exceed a threshold value, and wherein determining the value of the calibration parameter comprises using an objective function that maximizes the probability that each ultrasonic sensor of the pair of ultrasonic sensors correctly detects an object.

6. The vehicular ultrasonic sensing system of claim 3, wherein determining the value of the calibration parameter comprises using an augmented Lagrangian method.

7. The vehicular ultrasonic sensing system of claim 3, wherein the calibration parameter comprises a detection threshold parameter of the vehicular ultrasonic sensing system.

8. The vehicular ultrasonic sensing system of claim 1, wherein the probability that the respective ultrasonic sensor of the pair of ultrasonic sensors correctly detects an object in the field of sensing of the respective ultrasonic sensor is determined via determining an expected signal amplitude of the pair of ultrasonic sensors.

9. The vehicular ultrasonic sensing system of claim 8, wherein the expected signal amplitude of the pair of ultrasonic sensors is determined via generating, by a transducer model, data that simulates operation of the vehicular ultrasonic sensing system.

10. The vehicular ultrasonic sensing system of claim 1, wherein the probability that the respective ultrasonic sensor of the pair of ultrasonic sensors incorrectly detects an object that is not in the field of sensing of the respective ultrasonic sensor is determined via determining an expected intensity of noise received by the pair of ultrasonic sensors, and wherein the noise includes at least one selected from the group consisting of (i) reflections from the ground, (ii) signals from a different sensing system of the vehicle and (iii) signals from another ultrasonic sensor of the plurality of ultrasonic sensors.

11. A method for calibrating a vehicular ultrasonic sensing system, the method comprising:
disposing a plurality of ultrasonic sensors of the vehicular ultrasonic sensing system at a vehicle, each ultrasonic sensor of the plurality of ultrasonic sensors sensing exterior of the vehicle;
determining, for each respective ultrasonic sensor of a pair of ultrasonic sensors of the plurality of ultrasonic sensors, and based on processing by a data processor of the vehicle of sensor data captured by the respective ultrasonic sensor, a probability that the respective ultrasonic sensor of the pair of ultrasonic sensors correctly detects an object in a field of sensing of the respective ultrasonic sensor;
determining, for each respective ultrasonic sensor of the pair of ultrasonic sensors, and based on processing by the data processor of the vehicle of sensor data captured by the respective ultrasonic sensor, a probability that the respective ultrasonic sensor of the pair of ultrasonic sensors incorrectly detects an object that is not in the field of sensing of the respective ultrasonic sensor; and
calibrating the vehicular ultrasonic sensing system based at least in part on (i) the determined probability that each ultrasonic sensor of the pair of ultrasonic sensors correctly detects an object and (ii) the determined probability that each ultrasonic sensor of the pair of ultrasonic sensors incorrectly detects an object.

12. The method of claim 11, wherein calibrating the vehicular ultrasonic sensing system comprises determining a value of a calibration parameter of at least one ultrasonic sensor of the pair of ultrasonic sensors.

13. The method of claim 12, wherein determining the value of the calibration parameter comprises using an augmented Lagrangian method.

14. The method of claim 12, wherein the calibration parameter comprises a detection threshold parameter of the vehicular ultrasonic sensing system.

15. The method of claim 12, wherein determining the value of the calibration parameter comprises determining the value of the calibration parameter that causes the probability that each ultrasonic sensor of the pair of ultrasonic sensors correctly detects an object to exceed a threshold value, and wherein determining the value of the calibration parameter comprises using an objective function that minimizes the probability that each ultrasonic sensor of the pair of ultrasonic sensors incorrectly detects an object.

16. The method of claim 12, wherein determining the value of the calibration parameter comprises determining the value of the calibration parameter that causes the probability that each ultrasonic sensor of the pair of ultrasonic sensors incorrectly detects an object to not exceed a threshold value, and wherein determining the value of the calibration parameter comprises using an objective function that maximizes the probability that each ultrasonic sensor of the pair of ultrasonic sensors correctly detects an object.

17. The method of claim 11, wherein determining the probability that the respective ultrasonic sensor of the pair of ultrasonic sensors correctly detects an object in the field of sensing of the respective ultrasonic sensor comprises determining an expected signal amplitude of the pair of ultrasonic sensors.

18. The method of claim 17, wherein determining the expected signal amplitude of the pair of ultrasonic sensors comprises generating, by a transducer model, data that simulates operation of the vehicular ultrasonic sensing system.

19. The method of claim 11, wherein determining the probability that the respective ultrasonic sensor of the pair of ultrasonic sensors incorrectly detects an object that is not in the field of sensing of the respective ultrasonic sensor comprises determining an expected intensity of noise received by the pair of ultrasonic sensors, and wherein the noise includes at least one selected from the group consisting of (i) reflections from the ground, (ii) signals from a different sensing system of the vehicle and (iii) signals from another ultrasonic sensor of the plurality of ultrasonic sensors.

20. The method of claim 11, wherein the pair of ultrasonic sensors have overlapping fields of sensing.
